(19) United States
(12) Patent Application Publication
(10) Pub. No.: US 2025/0256718 A1
(43) Pub. Date: Aug. 14, 2025

(54) Travel Assistance Method and Travel Assistance Device

(71) Applicant: Nissan Motor Co., Ltd., Yokohama-shi, Kanagawa (JP)

(72) Inventors: Hiroyuki Matsunaga, Kanagawa (JP); Hirotoshi Ueda, Kanagawa (JP)

(21) Appl. No.: 19/116,784

(22) PCT Filed: Oct. 3, 2022
(86) PCT No.: PCT/JP2022/036953

§ 371 Date: Mar. 28, 2025

(51) Int. Cl. B60W 30/14; B60W 30/18; B60W 50/00; B60W 50/14; B60W 60/00

(52) U.S. Cl. CPC B60W 30/146; B60W 30/181; B60W 50/14; B60W 60/001; B60W 2050/0083; B60W 2050/143; B60W 2050/146; B60W 2520/10; B60W 2540/106

(57) ABSTRACT

A controller sets a stop candidate position at a stop line positioned on a travel route of a subject vehicle, executes deceleration control which decelerates the subject vehicle for the subject vehicle to stop before the stop candidate position, and autonomously controls traveling of the subject vehicle such that the subject vehicle passes the stop candidate position in a state where the setting of the stop candidate position is canceled or the stop candidate position is set when an accelerator operation is performed by a driver of the subject vehicle after the stop candidate position has been set.

### TECHNICAL FIELD

The present invention relates to a travel assistance method and a travel assistance device.

### BACKGROUND

There has been known a technique that executes deceleration assistance control which decelerates a vehicle just before a deceleration target and risk avoidance control which steers and decelerates the vehicle so as to avoid a risk factor. The technique notifies a vehicle driver of the deceleration target during a period in which the deceleration assistance control and the risk avoidance control simultaneously operate.

### SUMMARY

However, JP 2021-117916 A is an invention which executes deceleration control when a determination that deceleration is necessary for a stop line ahead of a vehicle is made based on information obtained by a sensor. Therefore, in JP 2021-117916 A, when it is difficult to determine whether deceleration is necessary for the stop line or passing is allowed, the deceleration of the vehicle for the stop line is not executed, and therefore, a driver needs to determine whether the driver can perform an accelerator operation while performing a brake operation, which poses a problem of an increased burden on the driver.

The present invention attempts to achieve an objective of providing a travel assistance method and a travel assistance device that enable reducing a burden on a driver even when it is difficult to determine whether deceleration for a stop line ahead of a vehicle is necessary or passing is allowed.

The present invention solves the above-described problem by setting a stop candidate position at a stop line positioned on a travel route of a subject vehicle, executing deceleration control which decelerates the subject vehicle for the subject vehicle to stop just before the stop candidate position, and autonomously controlling traveling of the subject vehicle such that the subject vehicle passes the stop candidate position in a state where the setting of the stop candidate position is canceled or the stop candidate position is set when an accelerator operation is performed by a driver of the subject vehicle after the stop candidate position has been set.

The present invention enables reducing a burden on a driver even when it is difficult to determine whether deceleration for a stop line ahead of a vehicle is necessary or passing is allowed.

### BRIEF DESCRIPTION OF THE DRAWINGS

FIG. 1 is a block diagram illustrating one embodiment of a travel assistance device according to the present invention;

FIG. 2 is a drawing illustrating an exemplary situation in which deceleration control according to the embodiment is executed;

FIG. 3 is a drawing illustrating an exemplary situation in which a travel assistance method according to the embodiment is executed;

FIG. 4 is a drawing illustrating an exemplary situation in which the travel assistance method according to the embodiment is executed; and

FIG. 5 is a flowchart diagram illustrating an exemplary procedure of the travel assistance method according to the embodiment.

### DETAILED DESCRIPTION

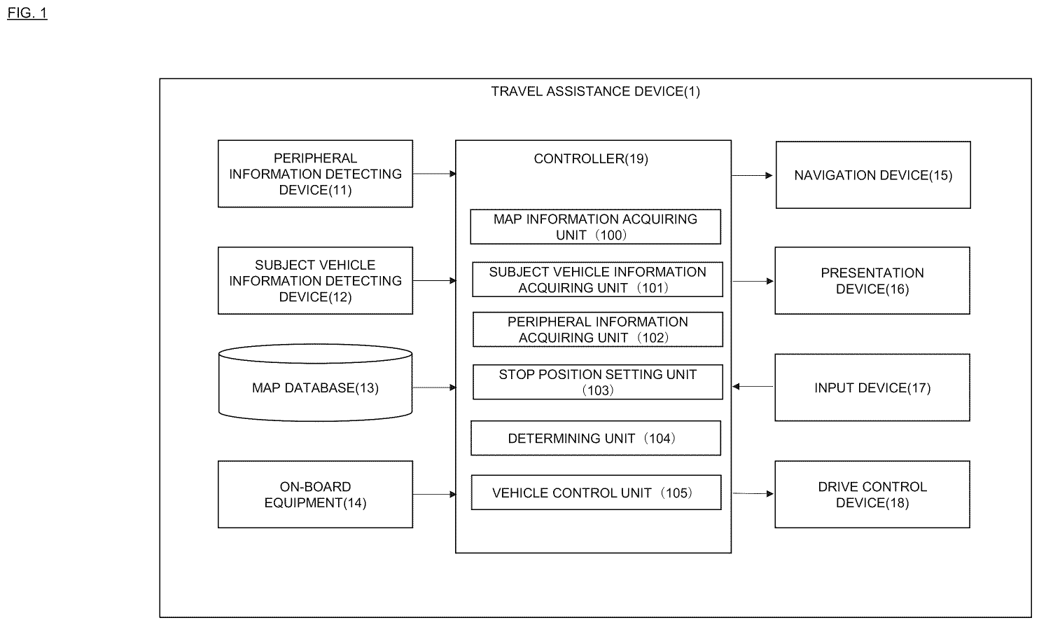

FIG. 1 is a block diagram illustrating a configuration of a travel assistance device 1 of a vehicle (hereinafter also referred to as a subject vehicle) according to the embodiment. The travel assistance device 1 of the embodiment is one embodiment executing a travel assistance method according to the present invention. As illustrated in FIG. 1, the travel assistance device 1 according to the embodiment includes a peripheral information detecting device 11, a subject vehicle information detecting device 12, a map database 13, on-board equipment 14, a navigation device 15, a presentation device 16, an input device 17, a drive control device 18, and a controller 19. These devices are connected by any in-vehicle LAN, such as a CAN, to mutually transmit and receive information. Note that, in the embodiment, as long as the travel assistance device 1 includes at least the controller 19, other configurations are not limited to the above-described configuration. For example, the map database 13 is not limited to being stored in the travel assistance device 1, and may be a database external to the travel assistance device 1.

The peripheral information detecting device 11 includes a sensor that detects an environment surrounding the subject vehicle. For example, the peripheral information detecting device 11 includes cameras, such as a front camera that obtains an image ahead of the subject vehicle, a rear camera that obtains an image behind the subject vehicle, and side cameras that obtain images of the right and left sides of the subject vehicle. In the embodiment, the peripheral information detecting device 11 recognizes traffic lane lines, stop lines, and the like by image recognition from the images taken by the cameras. The traffic lane lines include white lines, yellow lines, dashed lines, double lines, and the like. The peripheral information detecting device 11 includes radars, such as a front radar that detects an obstacle ahead of the subject vehicle, a rear radar that detects an obstacle behind the subject vehicle, and side radars that detect obstacles present on the right and left sides of the subject vehicle. The peripheral information detecting device 11 outputs detection results regarding the surrounding environment of the subject vehicle to the controller 19 as surrounding environment information at predetermined intervals.

The peripheral information detecting device 11 includes a distance sensor that obtains a distance from an object. The distance sensor includes a laser sensor, a depth camera, and the like. The peripheral information detecting device 11 includes a yaw rate sensor that obtains a yaw rate about a center axis of the subject vehicle. The yaw rate sensor obtains a yaw rate generated when the subject vehicle turns. The peripheral information detecting device 11 includes a lateral acceleration sensor that detects an acceleration rate in a lateral direction of the vehicle.

In the embodiment, the peripheral information detecting device 11 recognizes a stop line from images outside the vehicle taken by the front camera and the like, and measures a distance between the subject vehicle and the stop line. The peripheral information detecting device 11 detects signals of traffic lights, traffic signs, road markings, and the like positioned ahead in a traveling direction of the subject vehicle. Note that the peripheral information detecting device 11 may have a configuration using one of the above-described plurality of sensors or may have a configuration using two or more kinds of sensors in combination.

The subject vehicle information detecting device 12 includes a sensor that detects a traveling state of the subject vehicle. For example, the subject vehicle information detecting device 12 includes a vehicle speed sensor that detects a vehicle speed of the subject vehicle. The subject vehicle information detecting device 12 includes a steering angle sensor that detects a rudder angle of steering. The subject vehicle information detecting device 12 includes a GPS unit, a gyro sensor, a vehicle speed sensor, and the like. The subject vehicle information detecting device 12 detects radio waves transmitted from a plurality of satellite communications with the GPS unit, and periodically obtains location information of a target vehicle (the subject vehicle). The subject vehicle information detecting device 12 detects a current location of the subject vehicle based on the obtained location information of the subject vehicle, angle change information obtained from the gyro sensor, and the vehicle speed obtained from the vehicle speed sensor. The subject vehicle information detecting device 12 outputs the detected location information of the subject vehicle to the controller 19 at predetermined intervals.

The subject vehicle information detecting device 12 includes a sensor that detects an operation of the subject vehicle by a driver. The operation of the subject vehicle by the driver includes an accelerator operation and a brake operation. For example, the subject vehicle information detecting device 12 includes a sensor that detects a depression amount of an accelerator pedal by the driver. The subject vehicle information detecting device 12 outputs operation information including the depression amount of the accelerator pedal to the controller 19 when the operation of the accelerator pedal by the driver is detected. The subject vehicle information detecting device 12 may detect a depression period of the accelerator pedal by the driver.

The subject vehicle information detecting device 12 includes a sensor that detects a depression amount of a brake pedal by the driver. The subject vehicle information detecting device 12 outputs operation information including the depression amount of the brake pedal to the controller 19 when the operation of the brake pedal by the driver is detected. The subject vehicle information detecting device 12 may detect a depression period of the brake pedal by the driver.

The map database 13 is a database that stores map information including road information. The map database 13 is stored in a memory accessible from the controller 19. The road information stores each point on a map, such as an intersection and a junction, as a node, and a road section between the nodes as a road link. The road information includes information, such as road types, widths, and the numbers of traffic lanes of roads, curve roads and sizes of the curves (for example, curvatures or curvature radii), and speed limits set for the roads. The road information includes information on stop lines. The stop line is, for example, a stop line just before an intersection where a traffic light or a traffic sign and/or a road marking of a stop is installed. The information on stop lines includes location information of stop lines. The stop lines include virtual stop lines. The virtual stop line is a stop line conveniently installed on the map. For example, a virtual stop line is installed at a position where a stop is necessary for prioritizing passing of an oncoming vehicle in an intersection.

The on-board equipment 14 is various kinds of equipment mounted on the vehicle, and is operated by an operation of the driver. Examples of such on-board equipment include a steering wheel, an accelerator pedal, a brake pedal, turn signals, wipers, lights, a horn, other specific switches, and the like. When operated by the driver, the on-board equipment 14 outputs the operation information to the controller 19. For example, when the accelerator pedal or the brake pedal is operated by the driver, the operation information including an operation amount is output to the controller 19.

The navigation device 15 obtains current location information of the subject vehicle from the subject vehicle information detecting device 12, and displays the location of the subject vehicle overlapping map information for navigation on, for example, a display. The navigation device 15 includes a navigation function that, when a destination is set, sets a travel route to the destination and guides the driver on the set travel route. This navigation function displays the travel route on the map on the display, and notifies the driver of a route by, for example, audio.

The presentation device 16 includes various kinds of displays, such as a display included in the navigation device 15, a display incorporated in a rear-view mirror, a display incorporated in a meter portion, and a head-up display projected on a windshield, for example. The presentation device 16 includes devices other than the displays, such as speakers of an audio device. The presentation device 16 notifies the driver of various kinds of presentation information, following the control by the controller 19. For example, the presentation device 16 notifies the driver of setting cancel information by displaying the setting cancel information indicating a state where setting of a stop candidate position is canceled on the display or providing audio guidance by speakers.

The input device 17 is, for example, a device, such as a button switch that allows an input by the driver's manual operation, a touch panel arranged on a display screen, or a microphone that allows an input by the driver's voice. In the embodiment, the driver operates the input device 17, and thus, setting information relating to the presentation information presented by the presentation device 16 can be input. Note that a turn signal lever of a turn signal or other switches of the on-board equipment 14 may be used as the input device 17. The input device 17 outputs the input setting information to the controller 19.

The drive control device 18 autonomously controls traveling of the subject vehicle based on a target speed and a target rudder angle output from the controller 19. The control contents executed by the drive control device 18 include autonomous speed control and autonomous steering control. For example, when the subject vehicle travels at a constant speed of a setting speed by the autonomous speed control, the drive control device 18 controls an operation of a driving mechanism and an operation of a brake in order to accelerate and decelerate the subject vehicle, and maintain the traveling speed such that the subject vehicle has the target speed. The drive control device 18 similarly controls the operations of the driving mechanism and the brake also when the subject vehicle travels following a preceding vehicle by the autonomous speed control. In the embodiment, the drive control device 18 controls the operation of the brake when the subject vehicle is stopped at a stop line. Note that the operational control of the driving mechanism includes an operation of an internal combustion engine in the case of an engine vehicle and an operation of a traveling motor in the case of an electric vehicle system. The operational control of the driving mechanism includes torque distributions of an internal combustion engine and a traveling motor in the case of a hybrid vehicle.

The drive control device 18 controls an operation of a steering actuator in addition to the operational control of the driving mechanism and the brake described above by the autonomous steering control, and thus, executes the steering control of the subject vehicle such that the rudder angle of the steering wheel of the subject vehicle follows the target rudder angle. For example, the drive control device 18 executes the steering control such that the subject vehicle travels on a target traveling trajectory along a subject traffic lane by the autonomous steering control, and controls the traveling position (lateral position) in a width direction of the subject vehicle. The lateral position of the subject vehicle is a position of the subject vehicle in a width direction of the traffic lane (the width direction of the subject vehicle). In the embodiment, the lateral position of the subject vehicle includes the lateral position of the subject vehicle with respect to a traffic lane line and the lateral position of the subject vehicle with respect to the target traveling trajectory. The lateral position of the subject vehicle may be any positions of the subject vehicle, and is, for example, a position of the center of gravity of the subject vehicle in the width direction of the traffic lane. Another known method can be used as the vehicle control method by the drive control device 18.

The controller 19 includes a ROM that stores programs for autonomously controlling the traveling of the subject vehicle, a CPU that executes the programs stored in the ROM, a RAM that functions as an accessible storage device, and the like. Note that an MPU, a DSP, an ASIC, an FPGA, and the like can be used instead of or together with the CPU as an operation circuit. The controller 19 autonomously controls the traveling of the subject vehicle along a travel route by an autonomous speed control function and an autonomous steering control function. The controller 19 generates a target traveling trajectory on which the subject vehicle travels, computes a target speed and a target rudder angle at which the subject vehicle travels along the target traveling trajectory, and outputs the computed target speed and target rudder angle to the drive control device 18. In the embodiment, the autonomous speed control function includes a deceleration control function that decelerates the subject vehicle to, for example, stop the subject vehicle at a stop candidate position set at a stop line. The controller 19 executes the respective functions by collaboration of software and hardware for achieving the above-described respective functions or executing the above-described respective processes. In the embodiment, the controller 19 executes travel assistance control. The following describes the travel assistance control by the controller 19 in detail.

The controller 19 sets a stop candidate position at a stop line positioned on the travel route of the subject vehicle, and executes deceleration control which decelerates the subject vehicle for the subject vehicle to stop just before the stop candidate position. The controller 19 autonomously controls the traveling of the subject vehicle based on a determination of whether the subject vehicle can pass the stop candidate position. For example, the controller 19 cancels the deceleration control for the stop candidate position and autonomously controls the traveling of the subject vehicle such that the subject vehicle passes the stop candidate position when a determination that the subject vehicle can pass the stop candidate position is made even in the case where no accelerator operation is performed by the driver as described below.

The controller 19 executes the deceleration control which decelerates the subject vehicle to stop the subject vehicle just before the stop candidate position when the determination that the subject vehicle can pass the stop candidate position is not made. That is, when the stop candidate position is set, the controller 19 executes the deceleration control which decelerates the subject vehicle to stop the subject vehicle just before the stop candidate position unless the determination that the subject vehicle can pass the stop candidate position is made. The controller 19 cancels the setting of the stop candidate position and autonomously controls the traveling of the subject vehicle such that the subject vehicle passes the stop candidate position when an accelerator operation is performed by the driver even in the case where the determination that the subject vehicle can pass the stop candidate position is not made.

The controller 19 is configured by including a map information acquiring unit 100, a subject vehicle information acquiring unit 101, a peripheral information acquiring unit 102, a stop position setting unit 103, a determining unit 104, and a vehicle control unit 105 as function blocks. First, while for the controller 19 in the embodiment, the functions included in the controller 19 are divided into six blocks and functions of the respective function blocks are described, the functions of the controller 19 do not necessarily have to be divided into six blocks, and may be divided into five or less function blocks or seven or more function blocks.

The map information acquiring unit 100 obtains map information from the map database 13. The map information includes stop line information of stop lines. The stop lines include virtual stop lines.

The subject vehicle information acquiring unit 101 obtains subject vehicle information of the subject vehicle from the subject vehicle information detecting device 12. The subject vehicle information includes, for example, current location information of the subject vehicle. The subject vehicle information acquiring unit 101 obtains operation information of an accelerator operation or operation information of a brake operation by the driver as the subject vehicle information. The operation information of the accelerator operation includes a depression amount of the accelerator pedal and/or a depression period of the accelerator pedal. The operation information of the brake operation includes a depression amount of the brake pedal and/or a depression period of the brake pedal.

The peripheral information acquiring unit 102 obtains peripheral information indicating a surrounding environment of the subject vehicle from the peripheral information detecting device 11. The peripheral information includes peripheral road information. The road information includes, for example, stop lines positioned ahead in the traveling direction of the subject vehicle, signals of traffic lights, and traffic signs and road markings. The peripheral information includes obstacles in a peripheral area of the subject vehicle.

The stop position setting unit 103 sets a stop candidate position at a stop line positioned on the travel route of the subject vehicle. The stop candidate position is a position at which the determination of whether the subject vehicle can pass the stop candidate position needs to be made. The stop position setting unit 103 specifies a stop line positioned on the travel route based on the stop line information included in the obtained map information, and sets a stop candidate position at a position of the specified stop line. When there are a plurality of stop lines on the travel route, the stop position setting unit 103 sets stop candidate positions at respective positions of the plurality of stop lines.

The determining unit 104 determines whether the subject vehicle can pass the stop candidate position for the stop candidate position set by the stop position setting unit 103. In the embodiment, at the point when the determination that the subject vehicle can pass the stop candidate position is made, the traveling of the subject vehicle is autonomously controlled such that the subject vehicle passes the stop candidate position. That is, the deceleration control is continued to stop the subject vehicle just before the stop candidate position unless the determination that the subject vehicle can pass the stop candidate position is made. In the embodiment, the determining unit 104 determines whether the subject vehicle can pass the stop candidate position at constant intervals when the subject vehicle approaches the stop candidate position. When the subject vehicle approaches the stop candidate position is when it is determined that the subject vehicle is within a predetermined range from the stop candidate position.

The determining unit 104 determines whether the subject vehicle can pass the stop candidate position based on the peripheral information obtained by the peripheral information acquiring unit 102. The determining unit 104 determines that the subject vehicle can pass the stop candidate position when the situation ahead in the traveling direction of the subject vehicle is a situation in which the subject vehicle can pass the stop line. The case of being the situation in which the subject vehicle can pass the stop line is, for example, when a traffic light in an intersection where the stop line is installed shows a signal indicating that passing is permitted. The case of being the situation in which the subject vehicle can pass the stop line is when no obstacle that interferes with the traveling of the subject vehicle is present ahead in the traveling direction of the subject vehicle.

The determining unit 104 does not determine that the subject vehicle can pass the stop candidate position when the situation ahead in the traveling direction of the subject vehicle is a situation in which the subject vehicle cannot pass the stop line. The case of being the situation in which the subject vehicle cannot pass the stop line is, for example, when a traffic light installed in an intersection shows a signal indicating that passing is not permitted or when an obstacle that interferes with the traveling of the subject vehicle is present ahead in the traveling direction of the subject vehicle.

The determining unit 104 does not determine that the subject vehicle can pass the stop candidate position when it is difficult to determine whether the subject vehicle can pass the stop candidate position based on the peripheral information obtained by the peripheral information acquiring unit 102. For example, when the signal shown by the traffic light in the intersection where the stop line is installed is not recognizable, the determining unit 104 does not determine that the subject vehicle can pass the stop candidate position. Note that the determination of whether the subject vehicle can pass the stop candidate position is not a required configuration, and may be appropriately provided as necessary.

The determining unit 104 determines whether the accelerator operation is performed by the driver of the subject vehicle or not. The determining unit 104 determines that the accelerator operation is performed by the driver when the operation information of the accelerator operation by the driver is obtained. The determining unit 104 determines that the accelerator operation is not performed by the driver of the subject vehicle when the operation information of the accelerator operation by the driver is not obtained. For example, when it is difficult to determine whether the subject vehicle can pass the stop candidate position based on the peripheral information, that is, when the determination that the subject vehicle can pass the stop candidate position is not made, the determining unit 104 determines whether the accelerator operation is performed by the driver of the subject vehicle or not.

The determining unit 104 determines whether the accelerator operation is performed or not when the subject vehicle is decelerating to stop just before the stop candidate position. The determining unit 104 determines whether the accelerator operation is performed or not when the subject vehicle is within a predetermined range from the stop candidate position. Within the predetermined range from the stop candidate position is a range within a predetermined distance from the stop candidate position or a range in which a period that the subject vehicle takes to reach the stop candidate position is within a predetermined period.

The determining unit 104 may determine that the accelerator operation is performed when the operation information including a depression amount of the accelerator pedal less than the depression amount of the accelerator pedal by the driver for accelerating the subject vehicle is obtained. The depression amount of the accelerator pedal by the driver for accelerating the subject vehicle is a predetermined depression amount set in advance. Usually, the accelerator pedal has a mechanism with which acceleration control is not executed when the driver does not depress the accelerator pedal to equal to or more than a predetermined depression amount from the start of depressing. In the embodiment, when an accelerator operation with less than a predetermined depression amount for canceling the setting of the stop candidate position, not an accelerator operation with equal to or more than the predetermined depression amount for ordinary acceleration control, is performed, the determining unit 104 determines that the accelerator operation is performed. That is, in the embodiment, the accelerator operation is divided into an accelerator operation for ordinary acceleration and an accelerator operation for canceling the setting of the stop candidate position.

The determining unit 104 may determine that the accelerator operation is performed when the operation information including a depression period of the accelerator pedal less than the depression period of the accelerator pedal by the driver for accelerating the subject vehicle is obtained. The depression period of the accelerator pedal by the driver for accelerating the subject vehicle is a predetermined depression period set in advance. In the embodiment, when an accelerator operation for less than a predetermined depression period for canceling the setting of the stop candidate position, not an accelerator operation for equal to or more than the predetermined depression period for the ordinary acceleration control, is performed, the determining unit 104 determines that the accelerator operation is performed.

The determining unit 104 determines whether the brake operation is performed or not after canceling the setting of the stop candidate position. The determining unit 104 determines that the brake operation is performed by the driver when the operation information of the brake operation by the driver is obtained. The determining unit 104 determines that the brake operation is not performed by the driver of the subject vehicle when the operation information of the brake operation by the driver is not obtained.

In the embodiment, in the determination of whether the brake operation is performed, similarly to the accelerator operation, the determining unit 104 may determine that the brake operation is performed when a brake operation with less than a predetermined depression amount for canceling resetting of the stop candidate position, not a brake operation with equal to or more than the predetermined depression amount for ordinary deceleration control, is performed. The determining unit 104 may determine that the brake operation is performed when the brake operation for less than a predetermined depression period for canceling the resetting of the stop candidate position is performed.

The vehicle control unit 105 executes the deceleration control which decelerates the subject vehicle to stop the subject vehicle just before the stop candidate position when the stop candidate position is set. The vehicle control unit 105 starts the deceleration control of the subject vehicle to stop the subject vehicle just before the stop candidate position when the subject vehicle reaches a predetermined deceleration start position. The predetermined deceleration start position is a position separated from the stop candidate position by a distance necessary for appropriately stopping the subject vehicle just before the stop candidate position. In the embodiment, the vehicle control unit 105 executes the deceleration control for the set stop candidate position in principle after the stop candidate position has been set. When the determination that the passing is possible is made or when the accelerator operation is performed, the vehicle control unit 105 may autonomously control the traveling of the subject vehicle so as to pass the stop candidate position without stopping just before the stop candidate position. Note that, when the determination that the passing is possible is made, the configuration in which the traveling of the subject vehicle is autonomously controlled so as to pass the stop candidate position is not a required configuration, and may be appropriately provided as necessary. That is, the vehicle control unit 105 may execute the deceleration control for the set stop candidate position without determining whether the passing is possible.

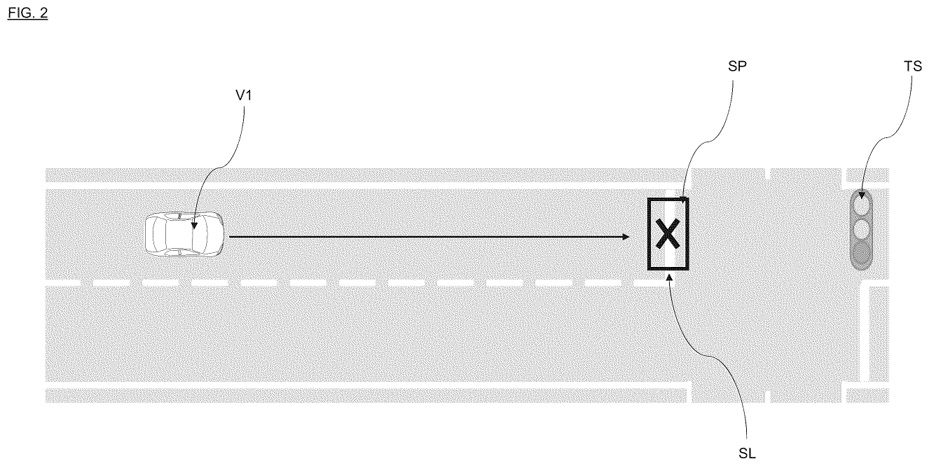

Here, with reference to FIG. 2, an exemplary situation in which the deceleration control according to the embodiment is executed is described. FIG. 2 is a drawing illustrating the exemplary situation in which the deceleration control according to the embodiment is executed. In FIG. 2, there are a stop line SL and a traffic light TS ahead in a traveling direction of a subject vehicle V1. A stop candidate position SP is set at a position of the stop line SL. When the determination that the subject vehicle can pass the stop candidate position is not made, the controller 19 executes deceleration control of the subject vehicle V1 such that the subject vehicle V1 stops just before the stop candidate position SP. For example, when a signal of the traffic light TS is not recognizable and the determination is difficult, the subject vehicle is stopped just before the stop candidate position SP even when the signal of the traffic light TS is a signal indicating permission of passing.

The vehicle control unit 105 autonomously controls the traveling of the subject vehicle based on the determination result by the determining unit 104. The vehicle control unit 105 cancels the setting of the stop candidate position and autonomously controls the traveling of the subject vehicle such that the subject vehicle passes the stop candidate position when the determination that the subject vehicle can pass the stop candidate position is made. That is, the vehicle control unit 105 causes the subject vehicle to pass without stopping just before the stop candidate position. For example, the vehicle control unit 105 cancels the setting of the stop candidate position and autonomously controls the traveling of the subject vehicle such that the subject vehicle travels at a set vehicle speed. The set vehicle speed is a vehicle speed set in advance. The set vehicle speed may be a vehicle speed set by the driver, or may be a vehicle speed set based on the road information. The road information, for example, may be information such as a speed limit indicated by a traffic sign detected by the peripheral information detecting device 11, or may be a speed limit set on a road obtained from the map database 13.

The vehicle control unit 105 executes the deceleration control which decelerates the subject vehicle to stop the subject vehicle just before the stop candidate position when the determination that the subject vehicle can pass the stop candidate position is not made. That is, the vehicle control unit 105 continuously executes the deceleration control unless the determination that the subject vehicle can pass the stop candidate position is made. For example, the vehicle control unit 105 executes the deceleration control when the situation ahead in the traveling direction of the subject vehicle is a situation in which the subject vehicle cannot pass the stop candidate position or when the determination of whether the subject vehicle can pass the stop candidate position is difficult.

The vehicle control unit 105 cancels the setting of the stop candidate position and autonomously controls the traveling of the subject vehicle such that the subject vehicle passes the stop candidate position when an accelerator operation is performed after the stop candidate position has been set. For example, the vehicle control unit 105 cancels the setting of the stop candidate position and autonomously controls the traveling of the subject vehicle such that the subject vehicle travels at the set vehicle speed when the determining unit 104 determines that the accelerator operation is performed. Note that, in the embodiment, the control executed by the vehicle control unit 105 when the accelerator operation is performed after the stop candidate position has been set is not limited to canceling the setting of the stop candidate position and autonomously controlling the traveling of the subject vehicle such that the subject vehicle passes the stop candidate position. The vehicle control unit 105 may autonomously control the traveling of the subject vehicle such that the subject vehicle passes the stop candidate position in a state where the stop candidate position is set when the accelerator operation is performed after the stop candidate position has been set. The vehicle control unit 105 autonomously controls the traveling of the subject vehicle such that the subject vehicle passes the stop candidate position without starting the deceleration control for the set stop candidate position when the accelerator operation is performed after the stop candidate position has been set and before the deceleration control is started. The vehicle control unit 105 cancels the deceleration control in execution and autonomously controls the traveling of the subject vehicle such that the subject vehicle passes the stop candidate position when the accelerator operation is performed while the deceleration control is executed after the stop candidate position has been set.

The vehicle control unit 105 may cancel the setting of the stop candidate position when the accelerator operation is performed in the case where the subject vehicle is decelerating to stop just before the stop candidate position or in the case where the subject vehicle is within the predetermined range from the stop candidate position. Note that limiting the condition for canceling the setting of the stop candidate position as described above is not a required configuration, and may be appropriately provided as necessary. For example, the vehicle control unit 105 may cancel the setting of the stop candidate position when the accelerator operation is performed in the case where the subject vehicle is not decelerating to stop just before the stop candidate position or in the case where the subject vehicle is outside the predetermined range from the stop candidate position.

The accelerator operation may be an accelerator operation for canceling the setting of the stop candidate position, that is, an accelerator operation including a depression amount or period of the accelerator pedal less than the depression amount or period of the accelerator pedal for accelerating the subject vehicle. The vehicle control unit 105 autonomously controls the traveling of the subject vehicle such that the subject vehicle passes the stop candidate position when the accelerator operation including the depression amount or the depression period for canceling the setting of the stop candidate position is performed. The vehicle control unit 105 may autonomously control the traveling of the subject vehicle such that the subject vehicle passes the stop candidate position when the accelerator operation including the depression amount and the depression period for canceling the setting of the stop candidate position is performed. Note that, as described above, limiting the accelerator operation to the accelerator operation including the depression amount or the depression period for canceling the setting of the stop candidate position is not a required configuration, and may be appropriately provided as necessary.

The vehicle control unit 105 may autonomously control the traveling of the subject vehicle such that the subject vehicle passes the stop candidate position at the set vehicle speed when the accelerator operation is performed after the deceleration control has been started. The set vehicle speed is, for example, a set vehicle speed of the subject vehicle before the subject vehicle starts the deceleration control. In the embodiment, the vehicle control unit 105 autonomously controls the traveling of the subject vehicle such that the subject vehicle travels at the set vehicle speed before the deceleration control is started. For example, the vehicle control unit 105 autonomously controls the traveling of the subject vehicle such that the subject vehicle travels at the set vehicle speed while the subject vehicle travels on the travel route until the subject vehicle reaches a deceleration start position. The vehicle control unit 105 autonomously controls the traveling of the subject vehicle based on the set vehicle speed of the subject vehicle before the deceleration control is started when the accelerator operation is performed after the deceleration control has been started. That is, the vehicle control unit 105 resumes the traveling of the subject vehicle based on the set vehicle speed before the deceleration control is started. Note that performing such autonomous control is not a required configuration, and may be appropriately provided as necessary.

The vehicle control unit 105 may autonomously control the traveling of the subject vehicle such that the subject vehicle continues the traveling at the set vehicle speed when the accelerator operation is performed before the deceleration control is started. That is, the vehicle control unit 105 autonomously controls the traveling of the subject vehicle such that the subject vehicle travels while maintaining the current set vehicle speed without starting the deceleration control when the accelerator operation is performed in the case where the vehicle control unit 105 is autonomously controlling the traveling of the subject vehicle such that the subject vehicle travels at the set vehicle speed before the deceleration control is started. Note that such autonomous control is not a required configuration, and may be appropriately provided as necessary. The accelerator operation may be an accelerator operation including the depression amount and the depression period for canceling the setting of the stop candidate position.

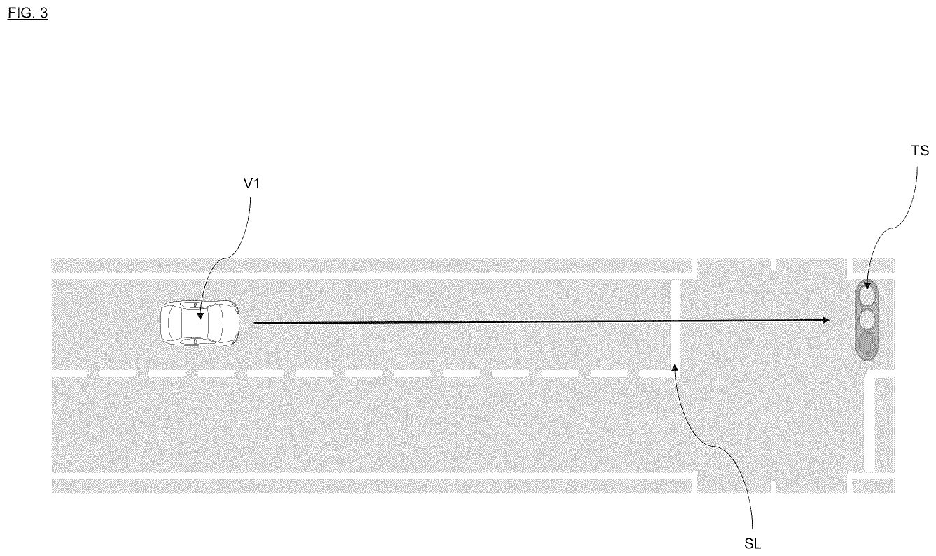

Here, with reference to FIG. 3, an exemplary situation in which a travel assistance method according to the embodiment is executed is described. FIG. 3 is a drawing illustrating the exemplary situation in which the travel assistance method according to the embodiment is executed. In FIG. 3, the stop line SL and the traffic light TS are present ahead in the traveling direction of the subject vehicle V1 similarly to the situation in FIG. 2. FIG. 3 illustrates a situation in which the stop candidate position set at the position of the stop line SL is canceled when the accelerator operation is performed while the subject vehicle is decelerating to stop just before the stop candidate position in the situation in FIG. 2. In such a case, the controller 19 autonomously controls the traveling of the subject vehicle V1 such that the subject vehicle V1 does not stop at the stop line SL but passes the stop line SL. For example, when the driver visually recognizes that the signal of the traffic light TS is the signal indicating permission of passing to perform the accelerator operation, the subject vehicle does not stop just before the stop line but passes the stop line. When the determination of whether the subject vehicle can pass the stop candidate position based on the peripheral information is difficult, the subject vehicle autonomously decelerates, and therefore, the driver does not need to perform the brake operation, and can concentrate on visually confirming the peripheral area to determine whether the stop candidate position can be passed.

The vehicle control unit 105 may accelerate the subject vehicle corresponding to the depression amount of the accelerator pedal when the accelerator operation is performed at the timing other than when the subject vehicle is decelerating to stop just before the stop candidate position. The accelerator operation is an accelerator operation for ordinary acceleration control. The timing other than when the subject vehicle is decelerating to stop just before the stop candidate position is, for example, when the subject vehicle is ordinarily traveling. Such a timing is when the subject vehicle is decelerating to avoid another moving body. The subject vehicle does not decelerate for the stop candidate position, but decelerates to avoid another moving body, such as a pedestrian crossing the road ahead of the subject vehicle. The driver performs the accelerator operation for the ordinary acceleration control after confirming the peripheral area to confirm that another moving body has been able to be avoided. In such a case, the vehicle control unit 105 accelerates the subject vehicle corresponding to the depression amount of the accelerator pedal by the driver. Note that the configuration as described above is not a required configuration, and may be appropriately provided as necessary.

Not that the vehicle control unit 105 does not cancel the setting of the stop candidate position and continues the deceleration control for stopping the subject vehicle just before the stop candidate position even though the accelerator operation for canceling the setting of the stop candidate position is performed at the timing other than when the subject vehicle is decelerating to stop just before the stop candidate position. For example, when the deceleration is performed to avoid the pedestrian in the case where the pedestrian is moving toward the front in the traveling direction of the subject vehicle from a sidewalk in the situation in FIG. 2, the vehicle control unit 105 does not cancel the setting of the stop candidate position even though the accelerator operation for canceling the setting of the stop candidate position is performed at this timing.

The vehicle control unit 105 cancels the setting of the stop candidate position for the stop line at a position closest to the subject vehicle when the accelerator operation is performed in the case where there are a plurality of stop lines positioned on the travel route. The vehicle control unit 105 specifies a stop line closest to the subject vehicle positioned ahead in the traveling direction of the subject vehicle among the plurality of stop lines and cancels the stop candidate position set at the stop line. Note that the configuration described above is not a required configuration, and may be appropriately provided as necessary.

The vehicle control unit 105 resets the stop candidate position at the stop line and resumes the control which stops the subject vehicle just before the stop candidate position when the brake operation is performed by the driver after the setting of the stop candidate position has been canceled. The vehicle control unit 105 switches canceling and resetting of the stop candidate position when the operation information of the accelerator operation or the brake operation is present. Note that the configuration as described above is not a required configuration, and may be appropriately provided as necessary.

The vehicle control unit 105 notifies the driver of the setting canceling information indicating the state where the setting of the stop candidate position is canceled via the presentation device 16 while the setting of the stop candidate position is canceled. For example, the vehicle control unit 105 displays an image indicating the setting canceling information on a display of the presentation device 16. The vehicle control unit 105 may output sound information including the setting canceling information via a speaker of the presentation device 16. Note that the configuration as described above is not a required configuration, and may be appropriately provided as necessary.

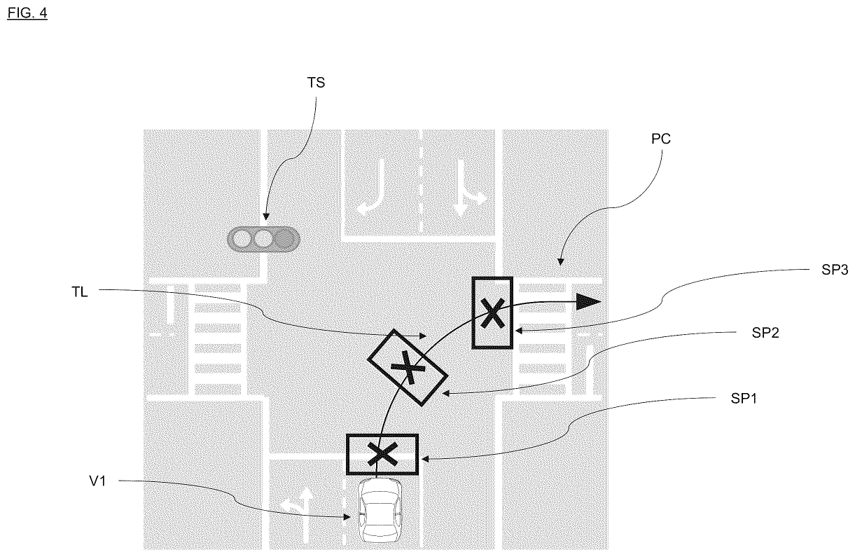

Here, with reference to FIG. 4, an exemplary situation in which the travel assistance method according to the embodiment is executed is described. FIG. 4 is a drawing illustrating the exemplary situation in which the travel assistance method according to the embodiment is executed. In FIG. 4, a plurality of stop candidate positions are set on a plurality of stop lines including virtual stop lines in an intersection. On a travel route TL of the subject vehicle V1, stop candidate positions SP1, SP2, and SP3 are set. The stop candidate position SP1 is set at the stop line drawn on a road surface. The stop candidate positions SP2 and SP3 are set at the virtual stop lines within the intersection. The virtual stop line at which the stop candidate position SP2 is set is at a position at which the subject vehicle needs to stop to prioritize an oncoming vehicle passing the intersection. The virtual stop line at which the stop candidate position SP3 is set is at a position at which the subject vehicle needs to stop to prioritize a pedestrian walking on a crosswalk PC.

As illustrated in FIG. 4, in the embodiment, the controller 19 cancels the stop candidate position SP1 closest to the subject vehicle when the accelerator operation is performed before the subject vehicle V1 enters the intersection. The controller 19 cancels the stop candidate position SP2 when the accelerator operation is further performed after the stop candidate position SP1 has been canceled. Similarly, the controller 19 cancels the stop candidate position SP3 when the accelerator operation is further performed after the stop candidate position SP2 has been canceled. As described above, the controller 19 cancels the stop candidate position in order from the stop candidate position closest to the subject vehicle by the accelerator operation.

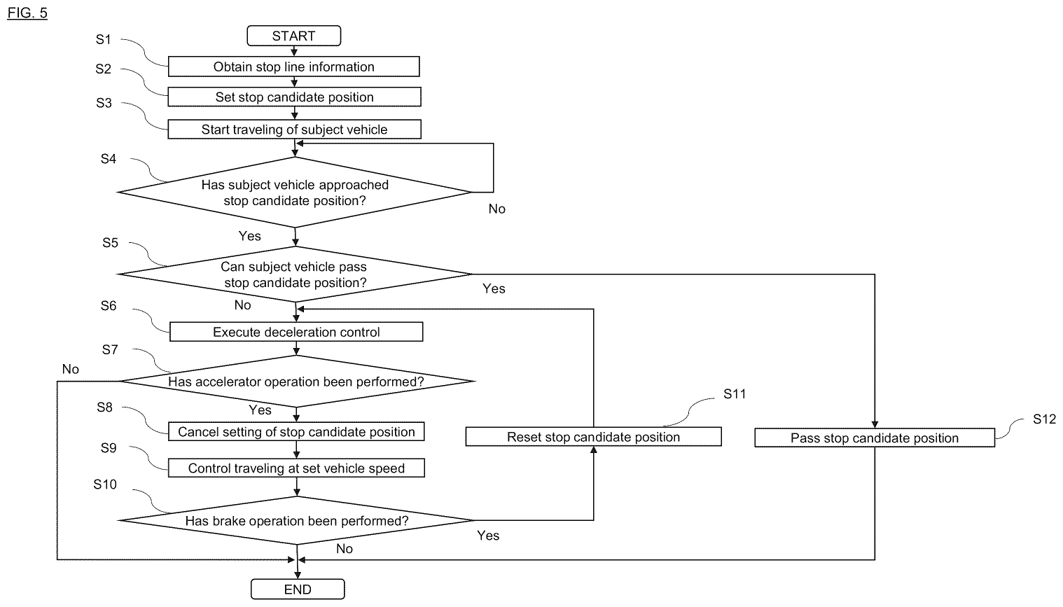

Next, with reference to a flowchart in FIG. 5, a procedure of the travel assistance method according to the embodiment will be described. FIG. 5 is a flowchart diagram illustrating an exemplary procedure of the travel assistance method according to the embodiment. In the embodiment, the controller 19 starts a process from Step S1 after the travel route of the subject vehicle has been set before the start of the traveling of the subject vehicle.

At Step S1, the controller 19 obtains the stop line information including the position of the stop line from the map database 13. At Step S2, the controller 19 sets the stop candidate position at the position of the stop line obtained at Step S1. At Step S3, the controller 19 autonomously controls the traveling of the subject vehicle so as to start the traveling of the subject vehicle. Note that Step S3 may be executed prior to Step S1 or prior to Step S2. At Step S4, the controller 19 determines whether the subject vehicle has approached the stop candidate position or not. For example, the controller 19 determines that the subject vehicle has approached the stop candidate position when the subject vehicle has reached a predetermined range from the stop candidate position.

When the determination that the subject vehicle has approached the stop candidate position is made, the controller 19 proceeds to Step S5. When the determination that the subject vehicle has approached the stop candidate position is not made, the controller 19 returns to Step S4 and repeats the following process. At Step S5, the controller 19 determines whether the subject vehicle can pass the stop candidate position. For example, when the signal of the traffic light is recognized as the signal indicating permission of passing based on the peripheral information, the controller 19 determines that the subject vehicle can pass the stop candidate position. When the determination that the subject vehicle can pass the stop candidate position is made, the controller 19 proceeds to Step S12. When the signal of the traffic light fails to be recognized as the signal indicating permission of passing or when the signal of the traffic light fails to be recognized, the controller 19 does not determine that the subject vehicle can pass the stop candidate position. When the determination that the subject vehicle can pass the stop candidate position is not made, the controller 19 proceeds to Step S6.

At Step S6, the controller 19 executes the deceleration control. At Step S7, the controller 19 determines whether the accelerator operation has been performed or not. The accelerator operation is, for example, the accelerator operation for canceling the setting of the stop candidate position. When the determination that the accelerator operation has been performed is made, the controller 19 proceeds to Step S8. When the determination that the accelerator operation has not been performed is made, the controller 19 controls the subject vehicle to continue the deceleration control and stop the subject vehicle just before the stop candidate position, and terminates the control process. In the embodiment, the controller 19 determines that the accelerator operation is performed when the operation information of the accelerator operation is obtained. When the operation information of the accelerator operation is not obtained, the controller 19 determines that the accelerator operation is not performed.

At Step S8, the controller 19 cancels the setting of the stop candidate position. At Step S9, the controller 19 autonomously controls the traveling of the subject vehicle at the set vehicle speed. At Step S10, the controller 19 determines whether the brake operation has been performed or not. When the determination that the brake operation has been performed is made, the controller 19 proceeds to Step S11. At Step S11, the controller 19 resets the stop candidate position canceled at Step S8. The controller 19 returns to Step S6 and repeats the following process after resetting the stop candidate position.

When the determination that the brake operation has not been performed is made, the controller 19 autonomously controls the traveling of the subject vehicle so as to continue the traveling control at the set vehicle speed and pass the stop line, and terminates the control process. In the embodiment, when the operation information of the brake operation is obtained, the controller 19 determines that the brake operation is performed. When the operation information of the brake operation is not obtained, the controller 19 determines that the brake operation is not performed. At Step S12, the controller 19 autonomously controls the traveling of the subject vehicle so as to pass the stop candidate position.

Note that, in the embodiment, the controller 19 executes the deceleration control after determining whether the subject vehicle can pass the stop candidate position, but the embodiment is not limited to this. In the case where the stop candidate position is set, the deceleration control may be started when the subject vehicle reaches the deceleration start position, and the determination of whether the subject vehicle can pass the stop candidate position may be made during the deceleration control. In the embodiment, when the subject vehicle has approached the stop candidate position, the deceleration control, and the determination of whether passing is possible or not and the determination of whether the accelerator operation is performed or not may be concurrently performed. In the embodiment, the controller 19 determines whether the accelerator operation is performed or not during the deceleration control after the deceleration control has been started, but the embodiment is not limited to this, and the determination of whether the accelerator operation is performed or not may be made before the subject vehicle starts the deceleration control, for example, when the subject vehicle is within the predetermined range from the stop candidate position. Note that the controller 19 may execute the control at and after Step S8 when the determination that the accelerator operation is performed is made before Step S6 after the determination of whether the accelerator operation is performed or not is made concurrently with the above-described control process and the determination that the subject vehicle has approached the stop candidate position is made at Step S4.

As described above, in the embodiment, a controller sets a stop candidate position at a stop line positioned on a travel route of a subject vehicle, and executes deceleration control which decelerates the subject vehicle for the subject vehicle to stop just before the stop candidate position. The controller autonomously controls traveling of the subject vehicle such that the subject vehicle passes the stop candidate position in a state where the setting of the stop candidate position is canceled or the stop candidate position is set when an accelerator operation is performed by a driver of the subject vehicle after the stop candidate position has been set. This enables reducing a burden on the driver even when a determination of whether the deceleration of the vehicle for a stop line ahead of the vehicle is necessary or not is difficult. In the embodiment, the controller is allowed not to execute the deceleration control while maintaining the setting of the stop candidate position or may cancel the deceleration control in execution, and may autonomously control the traveling of the subject vehicle such that the subject vehicle passes the stop candidate position when the accelerator operation is performed by the driver of the subject vehicle after the stop candidate position has been set.

In the embodiment, the controller autonomously controls the traveling of the subject vehicle such that the subject vehicle passes the stop candidate position in the state where the setting of the stop candidate position is canceled or the stop candidate position is set when the accelerator operation is performed in the case where the subject vehicle is decelerating to stop just before the stop candidate position or in the case where the subject vehicle is within a predetermined range from the stop candidate position. This enables autonomously controlling the traveling of the subject vehicle such that the subject vehicle does not stop just before the stop candidate position but passes the stop candidate position when the subject vehicle is decelerating for the stop line or when the subject vehicle is approaching the stop line.

In the embodiment, the controller autonomously controls the traveling of the subject vehicle such that the subject vehicle passes the stop candidate position in the state where the setting of the stop candidate position is canceled or the stop candidate position is set when the accelerator operation including a depression amount of an accelerator pedal less than a depression amount of the accelerator pedal by the driver for accelerating the subject vehicle is performed. This enables autonomously controlling the traveling of the subject vehicle such that the subject vehicle passes the stop line even with a depression amount equivalent to approximately a backlash of the accelerator pedal, although the vehicle is usually not accelerated when the depression amount equivalent to approximately the backlash of the accelerator pedal is detected.

In the embodiment, the controller autonomously controls the traveling of the subject vehicle such that the subject vehicle passes the stop candidate position in the state where the setting of the stop candidate position is canceled or the stop candidate position is set when the accelerator operation including a depression period of an accelerator pedal less than a depression period of the accelerator pedal by the driver for accelerating the subject vehicle is performed. This enables autonomously controlling the traveling of the subject vehicle such that the subject vehicle passes the stop line even with a short period of the accelerator operation, although acceleration control is usually performed while the accelerator pedal is operated when a depression amount of the accelerator pedal for a short period is detected.

In the embodiment, the controller accelerates the subject vehicle corresponding to a depression amount of an accelerator pedal when the accelerator operation is performed at a timing other than when the subject vehicle is decelerating to stop just before the stop candidate position. Therefore, the acceleration control is performed corresponding to the operation amount by the driver when the accelerator operation is performed other than when the subject vehicle is decelerating for the stop candidate position, thereby enabling the driver to drive as the driver intends.

In the embodiment, the controller autonomously controls the traveling of the subject vehicle such that the subject vehicle does not stop just before the stop candidate position but passes the stop candidate position in the state where the setting of the stop candidate position for the stop line at a position closest to the subject vehicle is canceled or the stop candidate position is set when the operation information is obtained in the case where a plurality of stop lines positioned on the travel route are present. Therefore, the setting of the stop candidate position is canceled in order from the stop line at the position closest to the subject vehicle even in a situation in which the plurality of stop lines are continuously present on the travel route of the subject vehicle, thereby enabling prevention of canceling the plurality of stop lines against the intension of the driver.

In the embodiment, the controller resets the stop candidate position at the stop line and resumes the deceleration control when a brake operation is performed by the driver after the setting of the stop candidate position has been canceled. This enables the deceleration control in line with the intension of the driver to decelerate with the brake pedal to be executed without continuing depressing the brake, thereby enabling reducing an operational load on the driver.

In the embodiment, the stop line includes a virtual stop line. Therefore, the stop line is virtually set even in a place where a stop line is not actually present but stop control is necessary (for example, a crosswalk), thereby enabling the subject vehicle to decelerate.

In the embodiment, the controller notifies the driver of setting canceling information indicating a state where the setting of the stop candidate position is canceled while the setting of the stop candidate position is being canceled. This enables the driver to understand that the setting of the stop candidate position is canceled and the subject vehicle is controlled to pass the stop line.

In the embodiment, the controller autonomously controls the traveling of the subject vehicle such that the subject vehicle travels at a set vehicle speed set in advance before the deceleration control is started; autonomously controls the traveling of the subject vehicle such that the subject vehicle passes the stop candidate position at the set vehicle speed when the accelerator operation is performed after the deceleration control has been started; and autonomously controls the traveling of the subject vehicle such that the subject vehicle continues the traveling at the set vehicle speed when the accelerator operation is performed before the deceleration control is started. This enables autonomously controlling the traveling of the subject vehicle at the set vehicle speed when the accelerator operation is performed by the driver.

The embodiment described above has been described for ease of understanding of the present invention, and has not been described to limit the present invention. Accordingly, each component disclosed in the above-described embodiment has a gist including even all the design changes and equivalents belonging to the technical scope of the present invention. Each configuration described in the above-described embodiment may be appropriately combined as necessary, and the combination of each of the configurations is not particularly limited.

### DESCRIPTION OF REFERENCE NUMERALS

1 Travel assistance device
19 Controller
100 Map information acquiring unit
101 Subject vehicle information acquiring unit
102 Peripheral information acquiring unit
103 Stop position setting unit
104 Determining unit
105 Vehicle control unit

1. A travel assistance method executed by a controller, the method comprising:
executing traveling control which autonomously controls traveling of a subject vehicle such that the subject vehicle travels at a set vehicle speed set in advance;
setting a stop candidate position at a stop line positioned on a travel route of the subject vehicle;
executing deceleration control which autonomously decelerates the subject vehicle for the subject vehicle to stop before the stop candidate position; and
autonomously controlling the traveling of the subject vehicle such that the subject vehicle passes the stop candidate position at the set vehicle speed when an accelerator operation is performed by a driver of the subject vehicle during the traveling control or the deceleration control.

2. The travel assistance method according to claim 1, further comprising:
autonomously controlling the traveling of the subject vehicle such that the subject vehicle passes the stop candidate position at the set vehicle speed when the accelerator operation is performed in a case where the subject vehicle is decelerating to stop before the stop candidate position or in a case where the subject vehicle is within a predetermined range from the stop candidate position.

3. The travel assistance method according to claim 1, further comprising:
autonomously controlling the traveling of the subject vehicle such that the subject vehicle passes the stop candidate position at the set vehicle speed when the accelerator operation of a depression amount of an accelerator pedal less than a depression amount of the accelerator pedal by the driver for accelerating the subject vehicle is performed.

4. The travel assistance method according to claim 1, further comprising:
autonomously controlling the traveling of the subject vehicle such that the subject vehicle passes the stop candidate position at the set vehicle speed when the accelerator operation of a depression period of an accelerator pedal less than a depression period of the accelerator pedal by the driver for accelerating the subject vehicle is performed.

5. The travel assistance method according to claim 1, further comprising:
accelerating the subject vehicle corresponding to a depression amount of an accelerator pedal when the accelerator operation is performed at a timing other than when the subject vehicle is decelerating to stop before the stop candidate position.

6. The travel assistance method according to claim 1, further comprising:
canceling setting of the stop candidate position for the stop line at a position closest to the subject vehicle and autonomously controlling the traveling of the subject vehicle such that the subject vehicle passes the stop candidate position at the set vehicle speed, or
autonomously controlling the traveling of the subject vehicle such that the subject vehicle passes the stop candidate position at the set vehicle speed in a state where the stop candidate position for the stop line at a position closest to the subject vehicle is set when the accelerator operation is performed in a case where a plurality of stop lines positioned on the travel route are present.

7. The travel assistance method according to claim 1, further comprising:
resetting the stop candidate position at the stop line and resuming the deceleration control when a brake operation is performed by the driver after the setting of the stop candidate position has been canceled.

8. The travel assistance method according to claim 1, wherein the stop line includes a virtual stop line.

9. The travel assistance method according to claim 1, further comprising:
notifying the driver of setting canceling information indicating a state where the setting of the stop candidate position is canceled while the setting of the stop candidate position is being canceled.

10. The travel assistance method according to claim 1, further comprising:
executing the traveling control-before the deceleration control is started;
autonomously controlling the traveling of the subject vehicle such that the subject vehicle passes the stop candidate position at the set vehicle speed when the accelerator operation is performed after the deceleration control has been started; and
autonomously controlling the traveling of the subject vehicle such that the subject vehicle continues the traveling at the set vehicle speed when the accelerator operation is performed before the deceleration control is started.

11. A travel assistance device comprising a controller configured to:
execute traveling control which autonomously controls traveling of a subject vehicle such that the subject vehicle travels at a set vehicle speed set in advance;
set a stop candidate position at a stop line positioned on a travel route of the subject vehicle, and executes deceleration control which autonomously decelerates the subject vehicle for the subject vehicle to stop before the stop candidate position; and
autonomously control the traveling of the subject vehicle such that the subject vehicle passes the stop candidate position at the set vehicle speed when an accelerator operation is performed by a driver of the subject vehicle during the traveling control or the deceleration control.
